(19) United States
(12) Patent Application Publication
(10) Pub. No.: US 2013/0073563 A1
(43) Pub. Date: Mar. 21, 2013

(54) ELECTRONIC COMPUTING DEVICE AND IMAGE SEARCH METHOD

(71) Applicant: Kouichirou KASAMA, Kawasaki (JP)

(72) Inventor: Kouichirou KASAMA, Kawasaki (JP)

(73) Assignee: FUJITSU LIMITED, Kawasaki-shi (JP)

(21) Appl. No.: 13/558,954

(22) Filed: Jul. 26, 2012

(30) Foreign Application Priority Data
Sep. 20, 2011 (JP) 2011-205079

(51) Int. Cl. G06F 17/30

(52) U.S. Cl. 707/748; 707/769; 707/E17.014; 707/E17.019

(57) ABSTRACT

An electronic computing device includes a database in which for multiple objects, data combining a first property value and a second property value representative of properties of images of each of the objects is accumulated by respectively changing the first property value and the second property value by given values; an acquirer that acquires image data; and an application processor that searches the database, extracts from the acquired first image data, a combination of the first property value and the second property value, and searches the database based on the extracted combination.

### CROSS REFERENCE TO RELATED APPLICATIONS

This application is based upon and claims the benefit of priority of the prior Japanese Patent Application No. 2011-205079, filed on Sep. 20, 2011, the entire contents of which are incorporated herein by reference.

### FIELD

The embodiments discussed herein are related to an electronic computing device and an image search method.

### BACKGROUND

Conventionally, there is a method of searching images by calculating degrees of similarity between colors that easily attract people's attention such as vivid colors, bright colors and the colors of objects in an image, and further weighting the degrees of similarity to calculate final degrees of similarity (see, for example, Japanese Laid-Open Patent Publication No. H11-212993). Further, there is a method of scanning image data in multiple directions that pass through the center of an image, to obtain density a co-occurrence matrix for pixels within a band-shaped region of a given width, where based on the density co-occurrence matrix, periodicity of the image as textural property value is extracted (see, for example, Japanese Laid-Open Patent Publication No. H11-66310).

Further, there is a method of comparing the values of various types of properties in input image data and the values of various types of properties in accumulated image data to search the accumulated image data for image data that is similar to the input image data (see, for example, Japanese Laid-Open Patent Publication No. 2001-319232). There is yet another method in which from among stored images associated with metadata that is of a different type for each of the stored images, image classes for each different metadata type are searched for based on the similarity between the metadata of different types and a sample image (see, for example, Published Japanese-Translation of PCT Application, Publication No. 2010-519659).

There is a method in which the property values acquired for multiple images are used, clusters to which the images belong are created, attributes of each cluster are determined, and an index associated with each cluster is created (see, for example, Japanese Laid-Open Patent Publication No. 2010-250634). Further, there is a method in which the property values acquired for multiple images are used, multiple clusters to which images of a given number or less (the number being determined by the calculation load at the time of image searching) are created, an attribute for each cluster is determined, and an index associated with each cluster is created (see, for example, Japanese Laid-Open Patent Publication No. 2010-250633).

Further, there is a method in which a perceptually significant property (e.g., a property provided by a preset certainty factor greater than 2) of a subject or the background of a first image is compared to a subject or the background of a second image; and the similarity of images determined (see, for example, Japanese Laid-Open Patent Publication No. 2008-262581). There is a further method in which for input image data and preliminarily registered image data, the amount of a property unchanged by rotation and indicative of a local texture centered around a given pixel is calculated for each pixel, based on the contrast of gray image data; and based on the calculated amount of the property, similar image data is searched for (see, for example, Japanese Laid-Open Patent Publication No. 2009-169925).

Nonetheless, with the conventional methods, image data of objects are randomly accumulated in a database. Accordingly, by mapping image data accumulated in the database by the 2 dimensions of shade and texture based on a combination of a shade indicative of the amount of image property and a texture, regions where image data is densely mapped and regions where image data is sparsely mapped occur. Thus, when image data accumulated in the database is searched for an image that is similar to a given image, if the combination of the shade and texture for the given image corresponds to a region where image data is sparely mapped, a problem arises in that a similar image cannot be retrieved with high accuracy.

### SUMMARY

According to an aspect of an embodiment, an electronic computing device includes a database in which for multiple objects, data combining a first property value and a second property value representative of properties of images of each of the objects is accumulated by respectively changing the first property value and the second property value by given values; an acquirer that acquires image data; and an application processor that searches the database, extracts from the acquired first image data, a combination of the first property value and the second property value, and searches the database based on the extracted combination.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of an electronic computing device according to a first embodiment;

FIG. 2 is a flowchart of an image search method according to the first embodiment;

FIG. 3 is a block diagram of a hardware configuration of a mobile device according to a second embodiment;

FIG. 4 is a block diagram of a functional configuration of the mobile device according to the second embodiment;

FIG. 5 is a diagram of a database according to the second embodiment;

FIG. 6 is a diagram of a 2-dimensional map obtained by mapping image data in the database according to the second embodiment;

FIG. 7 is a diagram of weighting data according to the second embodiment;

FIG. 8 is a flowchart of the image search method according to the second embodiment; and

FIG. 9 is a flowchart of a creation method of the database according to the second embodiment.

### DESCRIPTION OF EMBODIMENTS

Preferred embodiments of an electronic computing device and image search method will be explained with reference to the accompanying drawings. In the embodiments hereinafter, identical configuration elements are given the same reference numerals and redundant description is omitted.

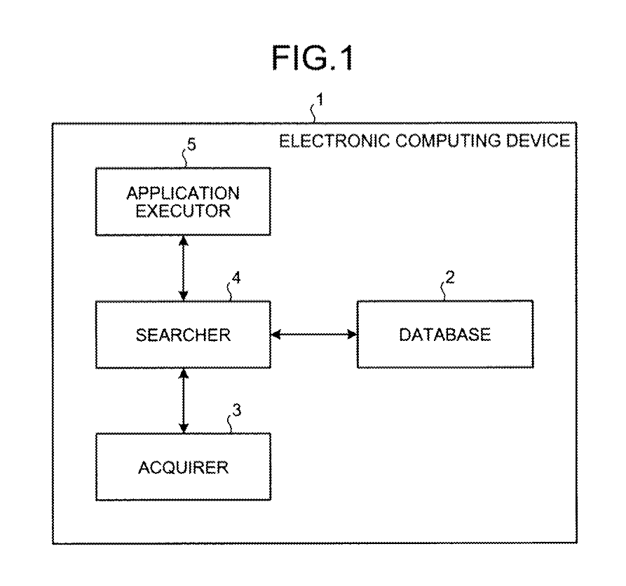

FIG. 1 is a block diagram of the electronic computing device according to a first embodiment. As depicted in FIG. 1, an electronic computing device 1 includes a database 2, an acquirer 3, a searcher 4, and an application executor 5.

The database 2 accumulates for multiple objects, data that are combinations of a first property value and a second property value representative of a property of an image of each object. The database 2 accumulates the combinations of the first property value and second property value data by respectively changing the first property value and the second property value by given values.

The acquirer 3 acquires image data. The searcher 4 searches the database 2. The application executor 5 extracts from first image data acquired by the acquirer 3, a combination of a first property value and a second property value. The application executor 5 causes the searcher 4 to search the database 2, based on the first property value and second property value combination extracted from the first image data.

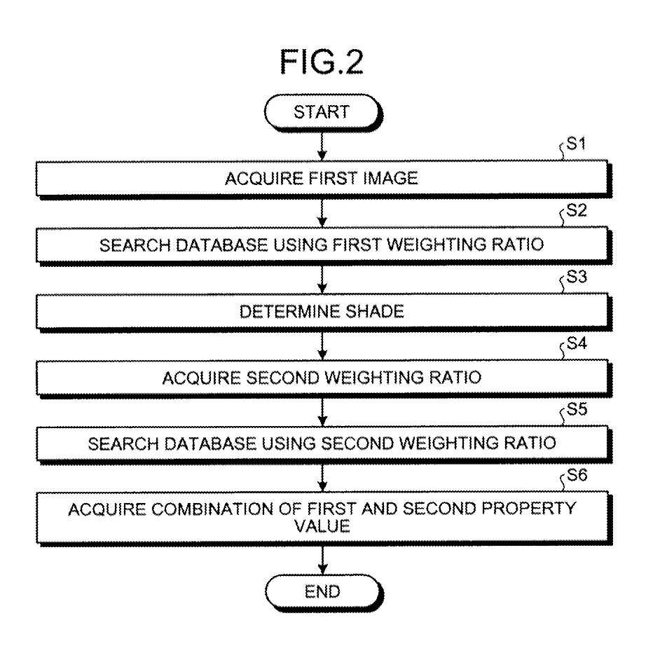

FIG. 2 is a flowchart of an image search method according to the first embodiment. As depicted in FIG. 2, when the image search method starts, the electronic computing device 1, via the acquirer 3, acquires a first image of an object (step S1). The electronic computing device 1, via the application executor 5, sets as a first weighting ratio, a weighting ratio of the first property value and the second property value that are representative of a property of the first image. The electronic computing device 1, via the searcher 4, searches the database 2 using the first weighting ratio (step S2).

The electronic computing device 1, via the application executor 5 and based on search results at step S2, determines a primary shade of the first image data (step S3). The electronic computing device 1, via the application executor 5, acquires from the weight data, a second weighting ratio of a first property value and a second property value for the primary shade determined at step S3 (step S4). In the weighting data, the weighting ratio of the first property value and the second property value is determined according to shade.

The electronic computing device 1, via the searcher 4, searches the database 2 using the second weighting ratio (step S5). The electronic computing device 1, via the application executor 5 and based on search results at step S5, acquires a combination of a first property value and a second property value, the acquired combination being in the database 2 and corresponding to the combination of the first property value and the second property value of the first image data (step S6).

According to the first embodiment, when based on the combination of the first property value and the second property value for given image data, the given image data accumulated in the database is mapped 2-dimensionally taking the first property value and the second property value as variables, a map uniformly mapping the image data can be obtained. Thus, in the map, image data is present that is nearly the combination of the first property value and the second property value of the acquired first image and therefore, image data that is similar to the first image data can be retrieved from among the image data accumulated in the database 2.

A second embodiment uses, for example, a mobile device such as a mobile telephone as the electronic computing device 1 and for example, is applied to a system that retrieves from the database 2, image data that is similar to the image data of a side dish.

A camera and/or a scanner may be given as an example of the acquirer 3. Alternatively, when image data stored in memory is to be read out from the memory, a file system may be given as an example of the acquirer 3. Further, when image data is to be acquired from a network such as the internet, a communication interface may be given as an example of the acquirer 3. Here, the acquirer 3 is assumed to be a camera equipped on the mobile device.

A search engine that retrieves from among the image data accumulated in the database 2, image data that is similar to image data of an image captured by, for example, the camera, may be given as an example of the searcher 4. As the search engine, a search engine that, for example, searches the database 2 based on the first property value and the second property value representative of a property of the image is sufficient.

A shade-related value, for example, may be given as an example of the first property value. A texture-related value, for example, may be given as an example of the second property value. Values related to shade or texture are obtained by, for example, image search processing (described hereinafter) executed by the application executor 5 and an execution of an image processing application when the database 2 is created.

Although in the database 2, parameters of tones (in multiple gradations) of principal colors of food are given as an example, configuration is not particularly limited hereto and for example, between ±20/256 gradations, data that has been changed every 1/256 gradation may be accumulated. Further, although configuration is not particularly limited hereto, for example, in the database 2, data that has been changed in multiple steps such as the ratios of regions of a principal color of food to regions exclusive thereof, given in, for example, 8 steps including 100:1, 50:1, 10:1, 7:1, 5:1, 3:1, 2:1, and 1:1 is accumulated.

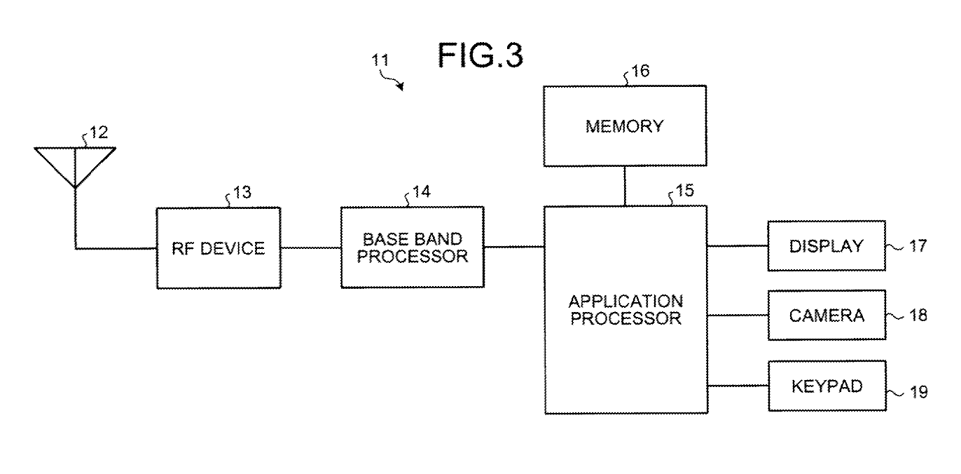

FIG. 3 is a block diagram of a hardware configuration of the mobile device according to the second embodiment. As depicted in FIG. 3, a mobile device 11 includes an antenna 12, a radio frequency (RF) device 13, and a base band processor 14 that performs base band processing. The RF device 13 and the base band processor 14 may be implemented on respectively independent integrated circuit (IC) chips or may be implemented on a single IC chip.

The mobile device 11 includes an application processor 15 that executes applications. The application processor 15 may be implemented on an independent IC chip. The application processor 15 may be connected to memory 16, an output device such as a display 17, and an input device such as a camera 18 and a keypad 19.

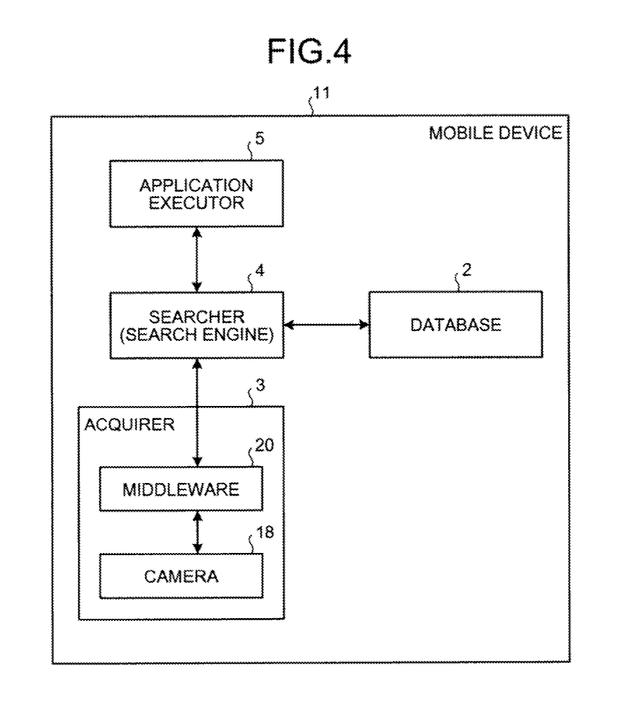

FIG. 4 is a block diagram of a functional configuration of the mobile device according to the second embodiment. As depicted in FIG. 4, the mobile device 11, similar to the electronic computing device 1 according to the first embodiment, includes the database 2, the acquirer 3, the searcher 4, and the application executor 5. The mobile device 11 includes the camera 18 and middleware 20 for the camera 18 as the acquirer 3. The database 2 is stored to the memory 16. Details concerning the database 2 will be described hereinafter.

The application executor 5 has weighting data determining the weighting ratio of the shade-related value and the texture-related value, according to shade. Details concerning the weighting data will be described hereinafter. The application executor 5 may give, for example, in descending order of degree of similarity, scores to the file names of the image data returned as a search result for the database 2 by the searcher 4.

The middleware 20 acquires from the camera 18, image data of, for example, the Joint Photographic Experts Group (JPEG) format. The size of the image data to be acquired may be, for example, a Video Graphics Array (VGA), i.e., a size of 640×480 dots or more.

The search engine of the searcher 4 searches the database 2 based on the weighting ratio of the shade-related value and the texture-related value, and extracts from the database 2, image data that is similar to the JPEG-formatted image data received from the middleware 20. The search engine extracts from the database 2, for example, the top 20 image data in descending order of degree of similarity and returns the extracted image data to the application executor 5.

Functions of the application executor 5, the search engine of the searcher 4, and the middleware 20 are respectively implemented by executing on the application processor 15, software implementing the functions. The software may be stored in the memory 16.

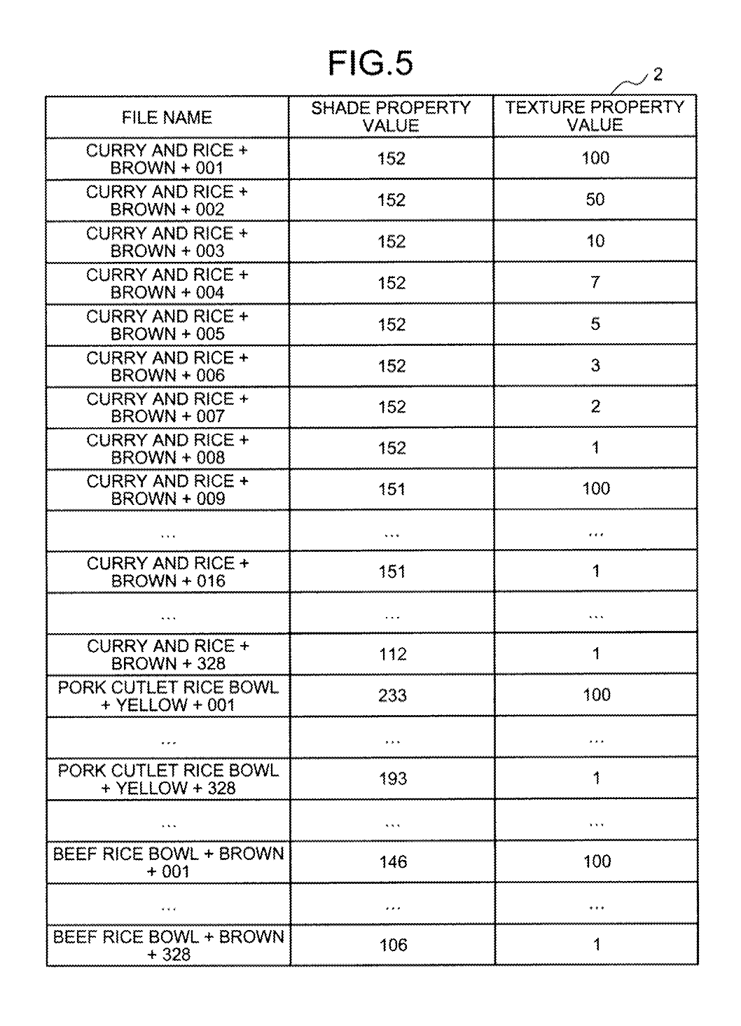

FIG. 5 is a diagram of the database according to the second embodiment. As depicted in FIG. 5, the database 2 stores image data for various types of food, such as curry and rice, a pork cutlet rice bowl, a beef rice bowl, etc. Meals included in, for example, “Standard Tables of Food Composition” prescribed by the Ministry of Education, Culture, Sports, Science and Technology, common, everyday meals and the like can be given as examples of the food. The image data may have a file name that, for example, includes “subject name(food name)+principal color of subject+sequential number”. A shade property value (shade-related value) and a texture property value (texture-related value) are correlated with the file name of each image data.

For the same food, data are accumulated that, for example, are parameters of tones of a principal color, changed every 1/256 gradation between ±20/256 gradations. For example, in the case of curry and rice, the accumulated image data is for a case where the shade has been changed to create 41 gradations from 112 to 152.

Further for the same food, data are accumulated that, for example, is the ratio of a region of a principal color and the region exclusive of the region of the principal color, changed in 8 steps including 100:1, 50:1, 10:1, 7:1, 5:1, 3:1, 2:1, and 1:1. Therefore, for each food, 328 image data are accumulated in the database 2. In the database 2 depicted in FIG. 5, texture property values “100”, “50”, etc. indicate values in the case of the respective ratios 100:1, 50:1, etc. above. Specific numeric values of each ratio are omitted herein.

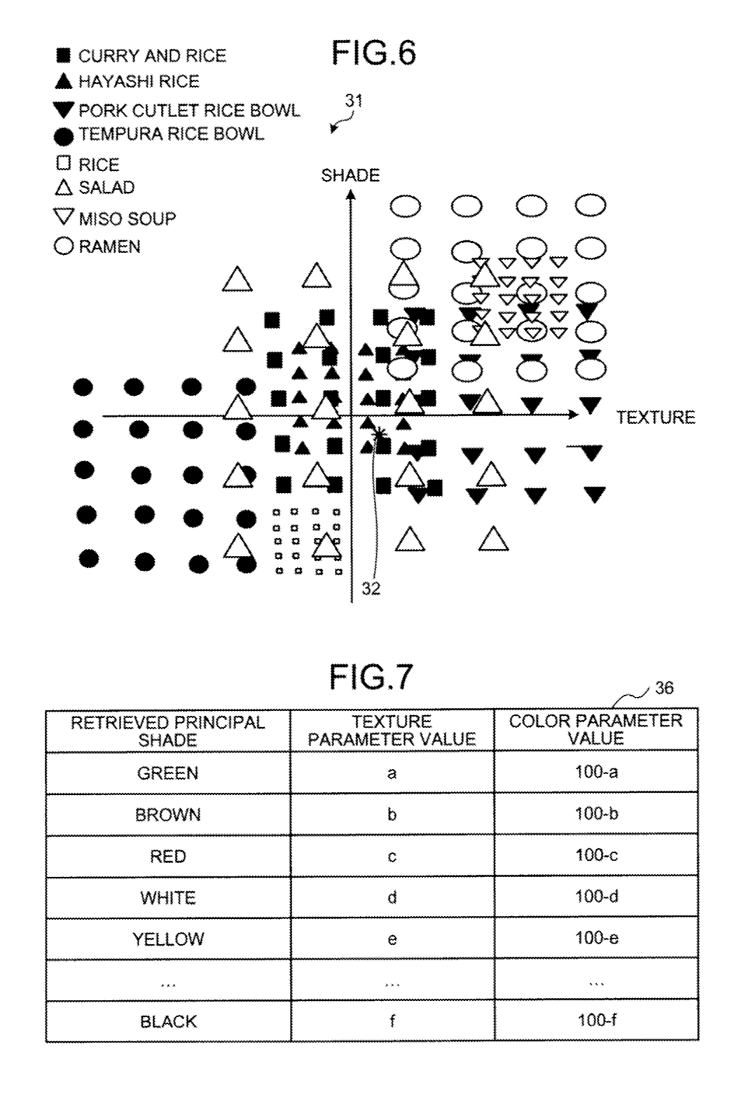

FIG. 6 is a diagram of a 2-dimensional map obtained by mapping the image data in the database according to the second embodiment. As depicted in FIG. 6, multiple image data for each food are plotted in a map 31. For example, for each food, a total of 328 image data, including 8 steps concerning texture and 41 gradations concerning shade, are plotted. However, for the sake of simplicity, in FIG. 6, the total number of image data depicted for each food is 20, including 4 steps concerning texture and 5 gradations concerning shade.

In the map 31, point 32 (asterisk (*)) represents the image data of an image captured by the camera 18. In this case, point 32 of the image data from the camera 18 is located among image data points for Hayashi rice and, curry and rice. Accordingly, food that is similar to the image of the food captured by the camera 18 is judged to be Hayashi rice and, curry and rice.

FIG. 7 is a diagram of weighting data according to the second embodiment. As depicted in FIG. 7, among weighting data 36, a texture parameter value and a color parameter value are prescribed for each shade. The weighting ratio of the texture-related value is determined by the texture parameter value. The weighting ratio of the shade-related value is determined by the color parameter value.

In FIG. 7, a to f are values from 0 to 100 and differ for each shade. In the drawing, although the sum of the texture parameter values and the color parameter values is 100, the sum need not be 100. The texture parameter value and the color parameter value for each color may be changed according to the search engine of the searcher 4 and according to whether the object is food, a flower, etc.

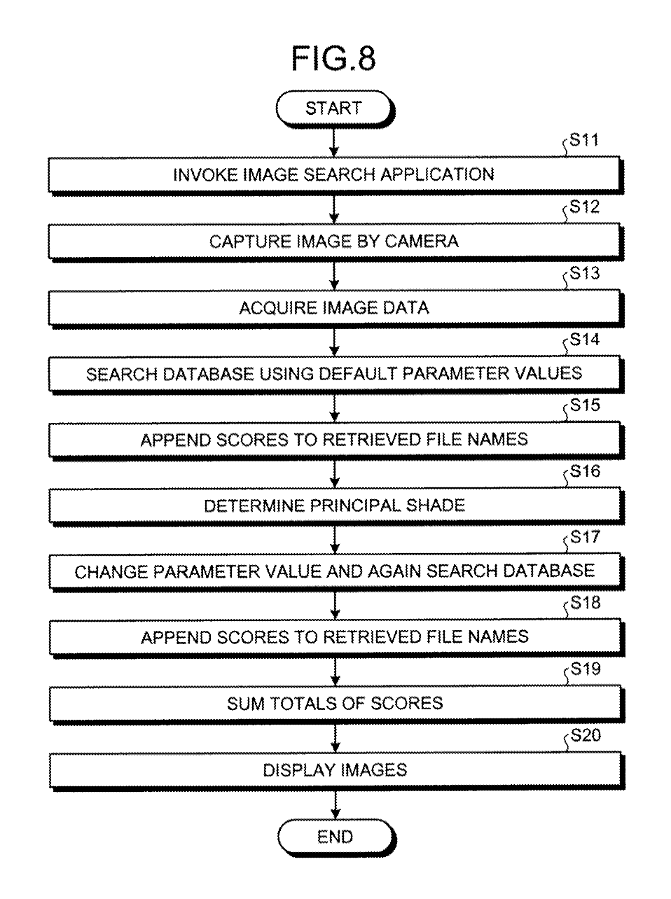

FIG. 8 is a flowchart of the image search method according to the second embodiment. As depicted in FIG. 8, when the image search processing starts, the mobile device 11 invokes an image search application (step S11), whereby the application executor 5, the searcher 4, and the middleware 20 for the camera 18 are realized by the mobile device 11. Triggered by the user pressing a button for the shutter of the camera 18 or by the user touching an image of a button on the display 17, the camera 18 captures an image of a food dish (step S12).

The searcher 4, through the middleware 20, acquires, for example, JPEG-formatted image data of the image captured by the camera 18 (step S13). The application executor 5 sets in the searcher 4, a default texture parameter value and a default color parameter value as the first weighting ratio. The default texture parameter value and the default color parameter value may be values such that the shade weight and the texture weight become, for example, 50%:50%.

The application executor 5 extracts from the image data captured at step S12 and transfers to the searcher 4, a shade-related value and a texture-related value. A known technology can be used as a method of extracting the shade-related value and the texture-related value from the image data. The searcher 4, based on the acquired combination of a shade-related value and texture-related value and according to the default texture parameter value and default color parameter value, searches the database 2 (step S14). The searcher 4 extracts from the database 2 and transfers to the application executor 5, the top 20 image data in descending order of degree of similarity.

The application executor 5 appends to the file names of, for example, the top 20 image data returned by the searcher 4 at step S14, scores corresponding to the sequence of the image data (step S15). The values of the scores, although not particularly limited hereto, may be, for example, 20 points for the top 5 image data, 15 points for the sixth to the tenth image data, and 5 points for the eleventh to the twentieth image data. Accordingly, the file name scores for the twenty-first image data and subsequent image data retrieved by the searcher 4 are each 0. The application executor 5 retains the score of each image data file name.

The application executor 5, among the top 20 image data returned by the searcher 4 at step S14, for example, the most frequently occurring shade among the shades of the top 5 image data is determined as the principal shade (step S16). The application executor 5 acquires as the second weighting ratio and from the weighting data 36, a texture parameter value that corresponds to the principal shade determined at step S16. The application executor 5 sets in the searcher 4, the texture parameter value acquired from the weighting data 36.

The searcher 4 changes the texture parameter value into a parameter value set by the application executor 5 and again searches the database 2 (step S17). The searcher 4 extracts from the database 2 and returns to the application executor 5, for example, the top 20 image data in descending order of degree of similarity.

The application executor 5 appends to the file names of, for example, the top 20 image data returned by the searcher 4 at step S17, scores corresponding to the sequence of the image data (step S18). The values of the scores, although not particularly limited hereto, may be identical to the values appended at step S15. The application executor 5 sums for each file name, a total of the scores appended to the file name at steps S15 and S18 (step S19).

The application executor 5 displays on the display 17, the names of the objects in and images of the files corresponding to the top 5 totals calculated at step S19 (step S20), ending the image search processing.

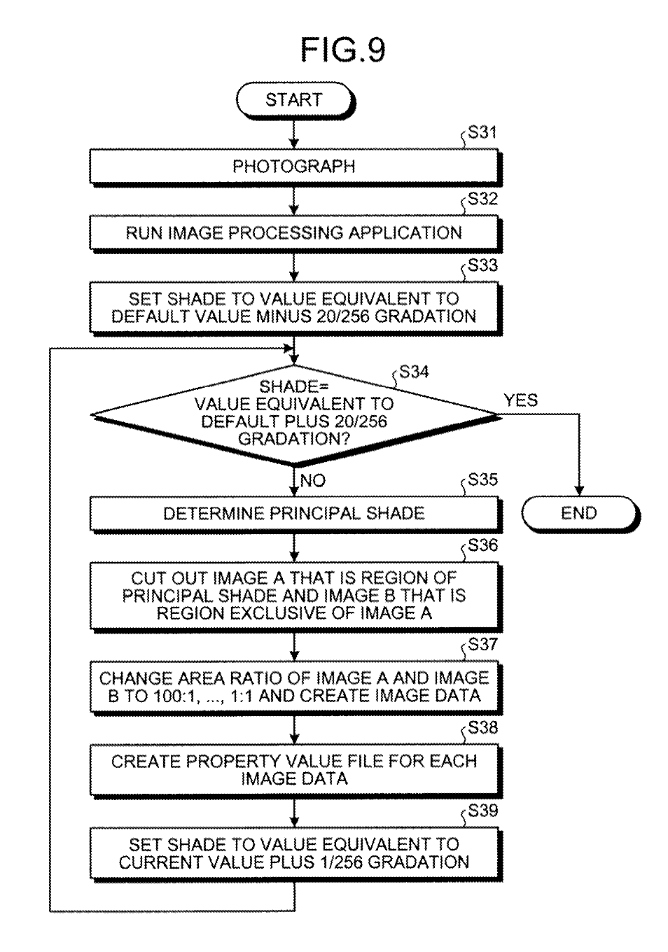

FIG. 9 is a flowchart of a creation method of the database according to the second embodiment. As depicted in FIG. 9, when a database creator starts the database creation processing, the database creator uses a digital camera, a camera on a camera-equipped mobile device to photograph food (step S31). The database creator, in place of photographing food, may photograph images of the food, read in images of the food by scanner, etc.

The database creator runs an image processing application and by the image processing application, opens the image data acquired at step S31 (step S32). The database creator operates the image processing application and sets a tone parameter value of the shade of the image data acquired at step S31 to a value equivalent to the default value minus 20/256 gradation (step S33).

The database creator judges whether the current tone parameter value of the shade is a value equivalent to the default plus 20/256 gradation (step S34). Until the current tone parameter value of the shade reaches a value equivalent to the default plus 20/256 gradation (step S34: NO), the database creator determines the most frequently occurring shade in the image data of current tone parameter value of the shade to be the principal shade (step S35).

The database creator operates the image processing application with respect to the image data of the current tone parameter value of the shade, and cuts out an image A that is a region of the principal shade determined at step S35 and an image B that is the region exclusive of the image A (step S36). The database creator operates the image processing application at step S36, and creates image data such that the area ratio of the cut out image A and the cut out image B becomes, for example, 100:1, 50:1, 10:1, 7:1, 5:1, 3:1, 2:1, and 1:1 (step S37).

The database creator creates a property value file for each image data created at step S37 (step S38). The database creator operates the image processing application, and sets the current tone parameter value of the shade of the image data acquired at step S31 to a value equivalent to the current value plus 1/256 gradation (step S39). The flow returns to step S34, and steps S34 to S39 are repeated until the tone parameter value of the shade reaches a value equivalent to the default value plus 20/256 gradation.

When the tone parameter value of the shade reaches a value equivalent to the default value plus 20/256 gradation (step S34: YES), the database creator, ends the database creation processing. The database creator uses the property value file created at step S38 for each image data, and creates the database 2.

According to the second embodiment, identical effects of the first embodiment can be achieved. Further, when food is photographed by the camera 18 of the mobile device 11, multiple candidates of the food photographed by the camera 18 are displayed on the display 17. The user, can, for example, operate the keypad 19 to select from among the candidates displayed on the display 17, one that corresponds to the food (actual food) photographed by the camera 18. Therefore, a record of food eaten by the user can be left in the mobile device 11. Furthermore, image data (of food) accumulated in the database 2 and information such as the nutritional content and the number of calories consumed when the food was eaten can be correlated, enabling records related to meals of the user to be created.

The object to be searched for is not limited to food and may be, for example, a flower. When the object to be searched for is a flower, the search engine may roughly classify flower types such as rose and carnation, and search for the flower type. Further, the electronic computing device 1 is not limited to the mobile device 11 and may be a personal computer, a personal digital assistant (PDA), etc.

According to the electronic computing device and image search method, from among accumulated image data, similar image data can be retrieved.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An electronic computing device comprising:
a database in which for multiple objects, data combining a first property value and a second property value representative of properties of images of each of the objects is accumulated by respectively changing the first property value and the second property value by given values;
an acquirer that acquires image data; and
an application processor that:
searches the database,
extracts from the acquired first image data, a combination of the first property value and the second property value, and
searches the database based on the extracted combination.

2. The electronic computing device according to claim 1, wherein
the first property value is a shade-related value, and
the database accumulates data indicative of a principal shade that is in an image and has been changed by multiple gradations.

3. The electronic computing device according to claim 1, wherein
the second property value is a texture-related value, and
the database accumulates data indicative a ratio of a region of the principal shade in the image to a region exclusive the region of the principal shade, the ratio being change by multiple steps.

4. The electronic computing device according to claim 1, wherein
the application processor has weighting data that determines a weighting ratio of the first property value and the second property value, according to the shade.

5. The electronic computing device according to claim 4, wherein
the application processor:
sets the weighting ratio of the first property value and the second property value as a first ratio,
searches the database and determines a principal shade of the first image data based on search results,
acquires for the principal shade and from the weighting data, a second weighting ratio of the first property value and the second property value,
searches the database using the acquired second weighting ratio, and
acquires a combination of the first property value and the second property value in the database and corresponding to a combination of the first property value and the second property value, based on search results obtained using the second weighting ratio.

6. An image search method comprising:
acquiring a first image of an object by searching a database for image data similar to a first image data, the database accumulating for multiple objects, data combining a first property value and a second property value representative of properties of images of each of the objects, the data being accumulated by respectively changing the first property value and the second property value by given values;
setting as a first weighting ratio representative of a property of the first image, a weighting ratio of the first property value and the second property value and searching the database,
determining based on a search result obtained using the first weighting ratio, a principal shade of the first image data;
acquiring from weighting data that determines a weighting ratio of the first property value and the second property value according to a shade, a second weighting ratio of the first property value and the second property value, for the principal shade;
searching the database using the acquired second weighting ratio;
acquiring a combination of the first property value and the second property value in the database and corresponding to a combination of the first property value and the second property value, based on the search result obtained by the searcher.

7. The image search method according to claim 6, wherein
the first property value is a shade-related value, and
the database accumulates data indicative of a principal shade that is in an image and has been changed by multiple gradations.

8. The image search method according to claim 6, wherein
the second property value is a texture-related value, and
the database accumulates data indicative a ratio of a region of the principal shade in the image to a region exclusive the region of the principal shade, the ratio being change by multiple steps.
